(19) United States
(12) Patent Application Publication
(10) Pub. No.: US 2025/0229481 A1
(43) Pub. Date: Jul. 17, 2025

(54) SYSTEMS, DEVICES, AND METHODS FOR LONG REPEAT PATTERN EMBOSSING

(71) Applicant: The AZEK Group LLC, Chicago, IL (US)

(72) Inventor: Daniel E. BOSS, Cincinnati, OH (US)

(21) Appl. No.: 19/029,469

(22) Filed: Jan. 17, 2025

Related U.S. Application Data
(60) Provisional application No. 63/621,716, filed on Jan. 17, 2024.

(51) Int. Cl. B29C 59/00; B29C 59/04; B29L 31/10

(52) U.S. Cl. CPC B29C 59/002; B29C 59/04; B29L 2031/10

(57) ABSTRACT

Aspects described herein are directed to embossing systems that facilitate deposition of three-dimensional patterns (e.g., wood gain), colorants (e.g., variegations, highlights, or shadows), or a combination thereof. Embossing systems may include a heating device positioned to expose a first surface of a substrate to thermal energy generated by a heat source. The embossing system may include one or more embossers positioned to apply an embossing pattern to the first surface of the substrate after exposure to the thermal energy generated by the heat source. The one or more embossers include a turning roller rotationally engageable with a first portion of an inner surface of an embossing belt, a pressure roller rotationally engageable with a second portion of the inner surface of the embossing belt. The outer surface of the embossing belt includes a negative relief of the embossing pattern.

### TECHNICAL FIELD

The present disclosure relates to systems, devices, and methods for the production of polymer-based building materials. More particularly, the present disclosure relates to systems that emboss patterns in a surface of substrate material (e.g., polymeric-based building materials).

### BACKGROUND

Manufactured alternatives to naturally occurring materials such as wood and stone can provide a number of advantages in construction and consumer products. For example, wood can rot, warp, splinter, discolor or bleach and stone can chip, shatter, discolor, or stain. Polymer-based materials forming a man-made alternative may be dent and impact resistant, resist rotting, include UV resistant additives, be sealed to prevent discoloration, and so on. Additionally, the cost of natural materials can be prohibitively expensive. That said, consumers might desire the aesthetic qualities of natural products. For example, the natural variations of wood that occur through woodgrain can be the aesthetic attribute that a consumer desires.

### BRIEF SUMMARY

One way to provide the aesthetic qualities of natural products is to emboss a pattern into or onto the surface of a substrate material (e.g., a polymer-based extrudate). Traditional embossing is done using a fixed diameter wheel that provides pressure and contains an embossing pattern that is the negative relief of the pattern that is desired on the substrate material. However, the circumference of the embossing roller/wheel sets the embossing pattern length before the pattern repeats. Accordingly, the systems and devices described herein provide embossing patterns that have a length before repeating that is independent of the diameter or circumference. For example in one aspect, an embossing system, includes a heating device positioned to expose a first surface of a substrate material to thermal energy generated by a heat source, a first Embosser positioned to apply an embossing pattern to the first surface of the substrate material after exposure to the thermal energy generated by the heat source, the first Embosser having a turning roller rotationally engageable with a first portion of an inner surface of an embossing belt, a pressure roller rotationally engageable with a second portion of the inner surface of the embossing belt, the embossing belt forming a loop with the inner surface and an outer surface, where at least a portion of the outer surface includes a negative relief of the embossing pattern disposed thereon, and a support roller positioned to receive a second surface of the substrate material that is opposite the first surface of the substrate material while at least a portion of the negative relief is pressed at least partially into the first surface of the substrate material.

In another aspect, an embossing device, includes a first embosser positioned to apply an embossing pattern to the first surface of the substrate material after exposure to the thermal energy generated by the heat source, the first embosser having a turning roller rotationally engageable with a first portion of an inner surface of the an embossing belt, a pressure roller rotationally engageable with a second portion of the inner surface of the embossing belt, the embossing belt forming a continuous loop and having a the inner surface and an outer surface, where at least a portion of the outer surface includes an negative relief of the embossing pattern disposed thereon, and a support roller positioned to receive a second surface of the substrate material that is opposite the first surface of the substrate material while at least a portion of the negative relief is pressed at least partially into the first surface of the substrate material.

### BRIEF DESCRIPTION OF THE DRAWINGS

To easily identify the discussion of any particular element or act, the most significant digit or digits in a reference number refer to the figure number in which that element is first introduced.

FIG. 1 illustrates an example system, according to aspects described herein;

FIGS. 2A and 2B illustrate example embossing systems, according to aspects described herein;

FIGS. 3A and 3B illustrate example multi-pattern embossing systems, according to aspects described herein;

FIG. 4 illustrates an example substrate material, in accordance with aspects described herein;

FIG. 5 depicts a perspective view of an example substrate material, in accordance with aspects described herein;

FIG. 6A depicts another perspective view of the example substrate material, in accordance with aspects described herein;

FIG. 6B depicts an enlarged portion of the perspective view depicted in FIG. 6A, in accordance with aspects described herein; and

FIG. 7 depicts a portion of another perspective view of an example substrate material, in accordance with aspects described herein.

### DETAILED DESCRIPTION

Traditionally embossing of substrate materials use a fixed diameter wheel. For example, a belt-press embosser operates by feeding the extruded polymer through several of heated wheels, which are equipped with engraved patterns. As the polymer passes through the wheels, the heat and pressure cause the material to soften and conform to the engraved patterns on the wheels. As such, the wheels include the embossing pattern (or the negative relief of the pattern desired on the polymer-based extrudate). The wheel also provides pressure such that the embossing pattern is embossed onto or into the surface of the polymer-based extrudate. However, traditional embossing systems are generally limited to embossing patterns equivalent to the circumference of a traditional embossing wheel, roller, or drum. Said differently, the diameter of the roller, wheel, or drum sets the embossing pattern length of traditional systems. This may limit the sophistication of the embossed pattern achievable via traditional embossing techniques. For example, the pattern provided by the wheel of a traditional roller may repeat multiple times on a substrate that is of sufficient length. Additionally, the traditional embossing rollers and drums may, after repeated use, collect remnant pieces of the surface material of the polymer-based extrudate. Clearing these remnant or scrap pieces often necessitates removing the embossing rollers and drums for a time-consuming cleaning process.

Accordingly, the present invention relates to systems, methods, and processes for material embossing that is facilitated by an embossing system. The embossing system includes a turning roller rotationally engageable with a first portion of an inner surface of an embossing belt, a pressure roller rotationally engageable with a second portion of the inner surface of the embossing belt, the embossing belt forming a loop with the inner surface and an outer surface, where at least a portion of the outer surface includes a negative relief of the embossing pattern disposed thereon, and a support roller positioned to receive a second surface of the material that is opposite the first surface of the material while at least a portion of the negative relief is pressed at least partially into the first surface of the material. Although the examples described herein are generally provided in relation to a polymer-based extrudate, the embossing systems may apply an embossing pattern on a surface of any material (e.g., a substrate), such as polymeric-based building materials; laminate, composite, or vinyl flooring; cement, clay, polymeric or composite floor, wall, or roofing tile; polymeric or composite furniture, countertops or cabinetry; polymer or composite decorative films/paper; or any material that is pliable to take a pattern prior to, and retain after, cooling, drying, curing, or hardening. Further, the substrate may be a sub component of a product. The embossed sub component substrate may be incorporated into the product when desired. For example, the embossing system may apply an embossing pattern on the surface of a polymer-based sub component. The embossed polymer-based sub component may then be affixed to one or more other layers to form the desired product. The sub component may be affixed via a chemical process, thermal process, any other suitable process, or any combination thereof.

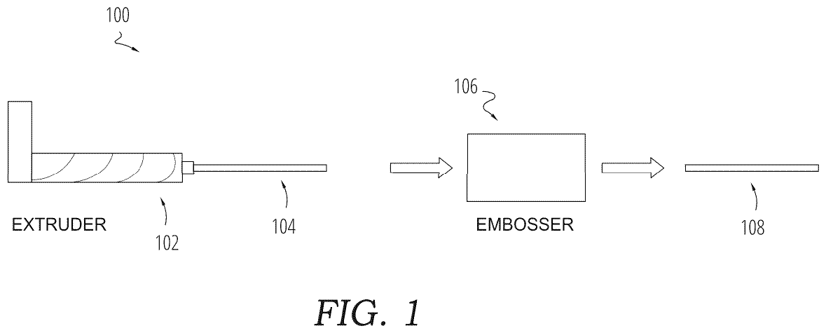

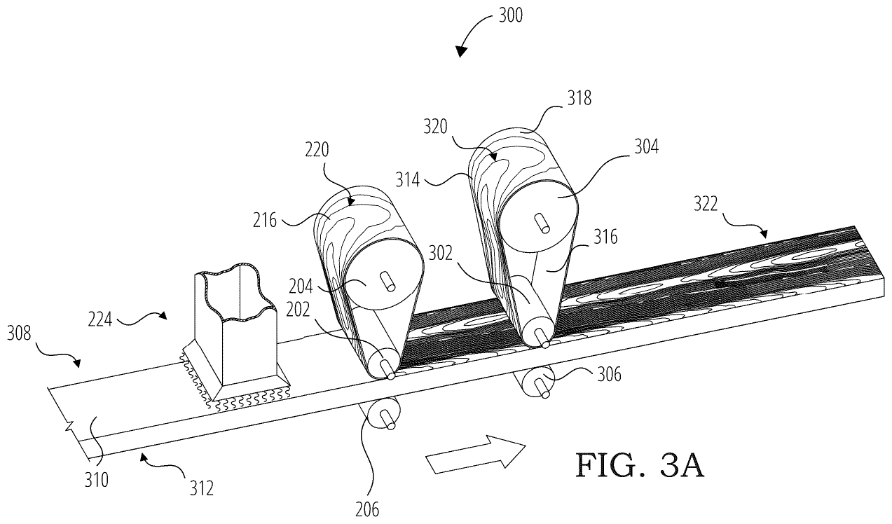

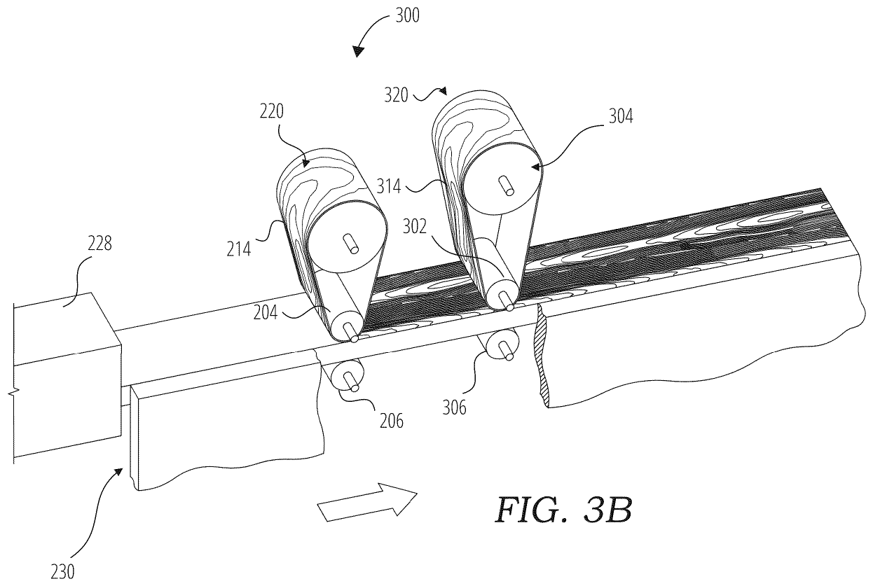

Turning to FIG. 1, an example embossing system 100 is depicted in accordance with aspects described herein. Generally, embossing system 100 facilitates the manufacture of a polymer-based material with at least one surface including an embossed pattern, such as polymer-based material 400 or 500 as described in relation to FIGS. 4 and 5. Some aspects of embossing system 100 includes one or more extruders 102 that extrudes a polymer-based extrudate 104. The polymer-based extrudate 104 may be transported to an embosser 106 to generate embossed polymer-based extrudate 108. The polymer-based extrudate 104 may be transported to the embosser 106 immediately after extrusion, after a predetermined curing time, or after long-term storage (i.e., any period of time beyond that associated with curing).

The extruder 102 may comprise one or more twin-screw extruder, one or more single screw extruders, or one or more conical extruders, or a combination thereof in some aspects. The extruder 102 may force a polymer-based mixture along an extrusion barrel and through an extrusion die of the desired gauge and cross-sectional pattern to produce polymer-based extrudate 104. The extrusion barrel may comprise a plurality of heating zones. Each heating zone can be controlled individually or in combination with other heating zones and facilitate thermal profiles for the extrusion barrel. The temperature of a heating zone can be in the range of 200° F. (i.e., 93.3° C.) and 500° F. (i.e., 260° C.). It is contemplated that any temperature may be set in any order within the contemplated range.

The example embossing system 100 depicted in FIG. 1 also includes a polymer-based extrudate 104. Polymer-based extrudate 104 may be extruded from extruder 102 in any width, thickness (gauge), or length. A newly formed polymer-based extrudate 104 may be cooled after exiting the extruder 102 via calender rollers, conveyers, or any other suitable system. In some aspects, the polymer-based extrudate 104 can be divided into two, more than two, or a plurality of sheets of uniform or non-uniform widths and lengths, such as described in relation to width 402 and length 404 of FIG. 4 and FIG. 5. Alternatively, the polymer-based extrudate 104 may not be intentionally cooled after exiting the extruder 102 prior to exposure to embosser 106. Similarly, other substrates (e.g., laminate, composite, or vinyl flooring; cement, clay, polymeric or composite floor, wall, or roofing tile; polymeric or composite furniture, countertops or cabinetry; polymer or composite decorative films/paper; any material that is pliable enough to take a pattern then cools, dries, cures, or hardens after embossing so as to retain the pattern) can be transported from an extruder, form, mold, or other system to an embosser 106 via calender rollers, conveyers, or any other suitable system.

The density of the polymer-based extrudate 104 vary determined based on the intended final use of the material. For example, the polymer-based sheet may be a cellular or foamed polymer-based material of varied density in some aspects. As will be understood by those skilled in the art, the temperature suitable for division can vary based on the specific composition of the mix used to manufacture the foamed sheet, the technique used to divide the foamed sheet by post-extrusion sizing process, manufacturing tolerances, and/or other factors. Post-extrusion sizing process can be a manually operated or computer-controlled saw, pressurized liquid cutting device, pressurized gas cutting device, or any other suitable cutting device. In some aspects, scrap portions (also referred to as regrind, recycled, or recovered) of the polymer-based extrudate 104 can be ground and reused.

The embosser 106 is generally designed for imparting three-dimensional patterns, textures, colorants, or a combination thereof, onto substrates (e.g., laminate, composite, or vinyl flooring; cement, clay, polymeric or composite floor, wall, or roofing tile; polymeric or composite furniture, countertops or cabinetry; polymer or composite decorative films/paper; any material that is pliable enough to take a pattern then cools, dries, cures, or hardens after embossing so as to retain the pattern), thereby enhancing their aesthetic and functional properties. The embosser 106 includes a turning roller rotationally engageable with a first portion of an inner surface of an embossing belt, a pressure roller rotationally engageable with a second portion of the inner surface of the embossing belt, the embossing belt forming a loop with the inner surface and an outer surface, where at least a portion of the outer surface includes a negative relief of the embossing pattern disposed thereon, and a support roller positioned to receive a second surface of the polymer-based extrudate that is opposite the first surface of the polymer-based extrudate while at least a portion of the negative relief is pressed at least partially into the surface of the polymer-based extrudate. The example embossing system 100 depicted in FIG. 1 also includes an embossed polymer-based extrudate 108. The embossed polymer-based extrudate 108 includes at least a portion of polymer-based extrudate 104 and includes an embossed pattern disposed on at least one surface.

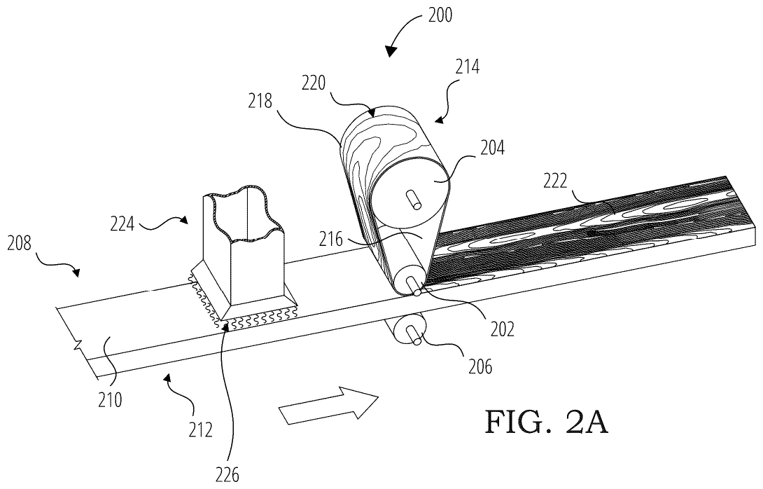

Turning to FIG. 2A, a selected set of components of embosser 200 are depicted in accordance with aspects described herein. Generally, an embossing device, such as embosser 200, includes a pressure roller 202, turning roller 204, support roller 206, and an embossing belt 214. The pressure roller 202 and support roller 206 are positioned such that embossing belt 214 applies an embossing pattern to the first surface 210 of the polymer-based extrudate 208 after exposure to thermal energy 226 generated by a heat source of the heating device 224. With brief reference to heating device 224, heating device 224 is responsible for precisely heating the polymer substrate to its optimal embossing temperature. The heating device 224 may include one or more heating sources such as electric resistance heating elements, infrared (IR) heating elements (e.g., IR lamp), near IR heating elements, mixed spectrum heating elements, incandescent heating elements (e.g., incandescent lamp), broad spectrum heating elements (e.g., broad spectrum lamp), steam heating elements, hot oil or thermal fluid heating elements, or a combination thereof. For example, one or more electric resistance heating elements, such as nickel-chromium (NiCr) or iron-chromium-aluminum (FeCrAl) wire-based elements, may be incorporated in heating device 224 such that at least one surface (e.g., first surface 210) of polymer-based extrudate 208 is directly or indirectly exposed to thermal energy 226. After exposer at least one surface of polymer-based extrudate 208 pliable and receptive to the embossing pattern while maintaining uniformity throughout the material. Post exposure, the polymer-based extrudate 208 is transported to an input area of embosser 200.

Returning to embosser 200, while the at least one surface of polymer-based extrudate 208 is pliable and receptive to embossing the polymer-based extrudate 208 is transported between support roller 206 and embossing belt 214 such that the pressure roller 202 applies sufficient resistive force to press the negative relief of embossing pattern 220 into first surface 210 of polymer-based extrudate 208. Pressure roller 202, support roller 206, or both may actively rotated (e.g., by mechanical, electromechanical, or computer control) or include a free rotational axis. For example, in at least one aspect support roller 206 is actively rotated in synchrony with pressure roller 202.

Pressure roller 202 and turning roller 204 are rotationally engageable with embossing belt 214 in some aspects. Said differently, rotation of pressure roller 202, turning roller 204, or both facilitates movement of embossing belt 214. As such, the negative relief of embossing pattern 220 disposed on the outer surface 218 of embossing belt 214 is continuously moved at a rate synchronized with the rate of translation of the polymer-based extrudate 208 through embosser 200. For example, pressure roller 202 may engage with embossing belt 214 via friction force engagement in some embodiments. Said differently, the embossing belt 214 is positioned over pressure roller 202 and turning roller 204, such that the inner surface 216 of embossing belt 214 makes contact with the outer surface of both rollers, creating a frictional force that propels the belt in a continuous loop. In such an embodiment, the position of pressure roller 202, turning roller 204, or both may be dynamically adjustable to maintain proper tensioning of embossing belt 214. In some aspects, pressure roller 202 may engage with a v-shaped embossing belt 214 (e.g., embossing belt 214 has a trapezoidal cross-section). In such an aspect, embossing belt 214 wraps around both pressure roller 202 and turning roller 204, and the V-shape of the belt corresponds to the groove profile of pressure roller 202 and turning roller 204. The driven roller rotates due to the friction between the embossing belt 214 and the roller groove. Additionally, or alternatively, some aspects of embosser 200 include tooth or cog engagement mechanisms with pressure roller 202 and embossing belt 214. Said another way, embossing belt 214 may include teeth that engage with cooperatively positioned and sized cavities in the surface of pressure roller 202, turning roller 204, or both. Alternatively, pressure roller 202, turning roller 204 or both may include teeth that engage with cooperatively positioned and sized cavities in the surface of embossing belt 214.

Accordingly, some embodiments of embosser 200 includes turning roller 204 rotationally engageable with a first portion of an inner surface 216 of the embossing belt 214. Some embodiments of embosser 200 include a pressure roller 202 rotationally engageable with a second portion of the inner surface 216 of the embossing belt 214. The embossing belt 214 may form a continuous loop that has an inner surface 216 and an outer surface 218, where at least a portion of the outer surface 218 includes a negative relief of embossing pattern 220 disposed thereon. Some embodiments of embosser 200 further include support roller 206 positioned to receive a second surface 212 of the polymer-based extrudate that is opposite the first surface 210 of the polymer-based extrudate 208 while at least a portion of the negative relief of embossing pattern 220 is pressed at least partially into the first surface 210 of the polymer-based extrudate 208. After the polymer-based extrudate 208 passes pressure roller 202, embossing belt 214, and support roller 206, an embossed polymer-based extrudate 222 if formed. Said another way, embossed polymer-based extrudate 222 includes the positive of negative relief of embossing pattern 220.

Further, it is contemplated that embosser 200 includes more than one turning roller 204. Although depicted as generally vertically aligned with pressure roller 202, the one or more turning rollers 204 may be positioned in any spatial relationship with pressure roller 202 that allows for the cyclical movement of embossing belt 214. As can be appreciated in view of the present description, incorporation of pressure roller 202, turning roller 204, and embossing belt 214 facilitates disassociating the length of the embossing pattern from the circumference of traditional embossing wheels. Rather, embossing belt 214 may be of any length sufficient to form a loop extending from pressure roller 202, turning roller 204, and back to pressure roller 202.

Additionally, though not depicted, it is contemplated that one or more support rollers (e.g., support roller 206) can be replaced with a pressure roller, turning roller, and embossing belt. Said differently, some embodiments of embosser 200 may be configured to emboss two surfaces of the substrate.

As mentioned above, some embodiments of embosser 200 may be associated with one or more heating devices (e.g., heating device 224). Generally, the heating device is incorporated into systems where increasing the temperature of the to-be-embossed material is desirable prior to embossing. For example, it may be desirable to heat intentionally cooled polymer-based extruded materials prior to embossing. However, embosser 200 may also facilitate embossing of polymer-based extruded materials or other substrates where it is not desirable for the temperature of the substrate to be increased prior to embossing. For example, the polymer-based extruded material may already be at a desired temperature, or a cementitious material may already have the desired malleability shortly after the material exits a molding device. Accordingly, and with reference to FIG. 2B, some embodiments of embosser 200 may receive the substrate from a device 228. Device 228 may be an extrusion die, a press (e.g., a laminate press), injection mold, vacuum mold, or any other device that outputs a substrate in condition for embossing.

Additionally, some embodiments of embosser 200 may include one or more resistive elements 230. Generally, a resistive element facilitates, at least partial, maintenance of a substrates profile (e.g., width, thickness) before embossing, during embossing, after embossing, or a combination thereof. Said differently, the resistance element provides a rigid or semi-rigid barrier that, at least partially, prevents the pressure applied by the embosser 200 from unintentionally deforming the substrate's profile. For example, as depicted in FIG. 2B, the resistive elements 230 may include a wall. The resistive elements 230 may extends from a point prior to where to the substrate is transported between support roller 206 and embossing belt 214 such that the pressure roller 202 applies sufficient resistive force to press the negative relief of embossing pattern 220 into a first surface of the substrate. The resistive elements 230 may be coextensive with the support roller 206, embossing belt 214, and pressure roller 202. Similarly, the extend past the support roller 206, embossing belt 214, and pressure roller 202. Though not depicted, the resistive elements 230 may also include a plurality of rollers. For example, a plurality of rollers may be aligned along the path the substrate takes through embosser 200.

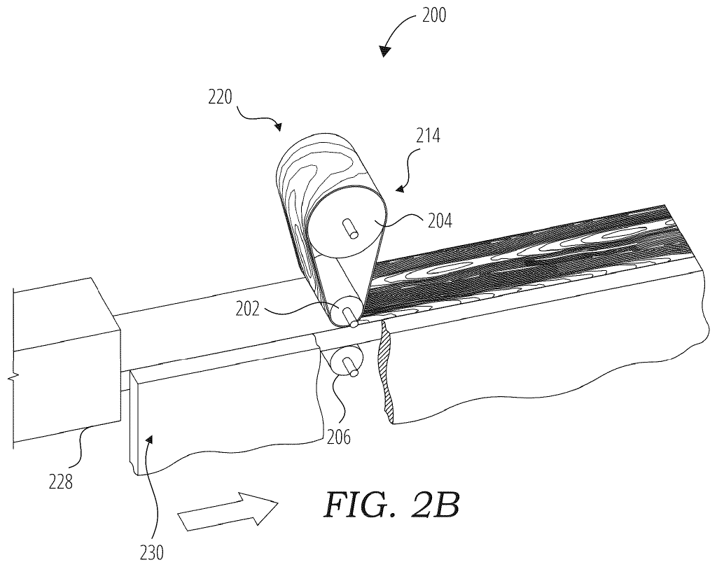

Turning to FIG. 3A, a selected set of components of embosser 300 are depicted in accordance with aspects described herein. Generally, embosser 300 facilitates deposition of at least two embossing patterns onto a surface (e.g., first surface 310) of a polymer-based extrudate (e.g., polymer-based extrudate 308). The embossing patterns may include three dimensional patterns (e.g., wood gain), colorants (e.g., variegations, highlights, or shadows), or a combination thereof. A colorant may be deposited at predetermined points of a negative relief of embossing pattern via a colorant deposition system (e.g., digital print, flexographic, and so forth) that is incorporated into an embosser 300. Similar to embosser 200 of FIG. 2A, some embodiments of embosser 300 include a heating device 224 that exposes at least one surface of the polymer-based extrudate to thermal energy.

Embosser 300 includes at least two embossing stations. In some aspects, the first embossing station includes a pressure roller 202, turning roller 204, support roller 206, and an embossing belt 214. Similar to embosser 200 of FIG. 2A, the pressure roller 202 and support roller 206 are positioned such that embossing belt 214 applies a first embossing pattern to the first surface 310 of the polymer-based extrudate 308 after exposure to a heat source of the heating device 224. The first embossing pattern may include three dimensional patterns (e.g., wood gain), colorants (e.g., variegations, highlights, or shadows), or a combination thereof.

Additionally, the second embossing station of embosser 300 includes pressure roller 302, turning roller 304, support roller 306, and embossing belt 314. Similar to the first embossing station, pressure roller 302, turning roller 304, support roller 306, and embossing belt 314 are positioned such that embossing belt 314 applies a second embossing pattern to the first surface 310 of the polymer-based extrudate 308 after the first embossing pattern is applied. The second embossing pattern may include three dimensional patterns (e.g., wood gain), colorants (e.g., variegations, highlights, or shadows), or a combination thereof.

In some embodiments of embosser 300, each embossing station includes more than one turning roller (e.g., turning roller 204). Said differently, embodiments of the first embossing station can include a pressure roller 202, one or more turning rollers 204, support roller 206, and an embossing belt 214. Similarly, in some embodiments the second embossing station of embosser 300 includes pressure roller 302, one or more turning rollers 304, support roller 306, and embossing belt 314. Although depicted as generally vertically aligned with the pressure rollers, the one or more turning rollers may be positioned in any spatial relationship with associated pressure roller that allows for the cyclical movement of embossing belt.

Further, in some embodiments embosser 300 includes a central control unit configured to control the timing and synchronization of the two or more embossing stations of embosser 300. In some aspects, the control unit regulates the rotational speed and positioning of pressure roller 202, pressure roller 302, turning roller 204, turning roller 304, support roller 206, support roller 306, embossing belt 214, embossing belt 314, or a combination thereof. Accordingly, the central control unit of embosser 300 may facilitate the co-operative alignment of the embossing pattern generated by negative relief of embossing pattern 220 and the embossing pattern generated by negative relief of embossing pattern 320 on the first surface 310.

In some aspects, the control unit continuously monitors the patterns generated by each embossing station. For example, the control unit may be communicatively coupled with one or more optical sensors, image recognition technology, or other detection sensor to register and analyze the embossed patterns. Deviations or discrepancies in the embossing pattern are corrected by adjusting the rotational speed or position of the embossing rollers, thus facilitating pattern alignment and overlapping. For example, an indexing mark may be included on the inner surface 316 of an embossing belt (e.g., embossing belt 214, embossing belt 314, or both). For another example, an indexing mark may be included on the outer edge 318 of an embossing belt (e.g., embossing belt 214, embossing belt 314, or both). The control unit may monitor the indexing marks of the embossing belts to determine the alignment of the patterns are properly aligned to produced the desired embossing pattern of the embossed polymer-based exudate 322.

Additionally, or alternatively, the control unit may include one or more detector configured to monitor the pressure roller 202, pressure roller 302, turning roller 204, turning roller 304, support roller 206, support roller 306, embossing belt 214, embossing belt 314, or a combination thereof. For example, one or more detectors may monitor the pressure applied by the pressure roller 202 and turning roller 206; the pressure applied by the pressure roller 302 and turning roller 306; the speed of rotation of pressure roller 202, turning roller 206, pressure roller 302, turning roller 306, or any combination thereof; the temperature of pressure roller 202, pressure roller 302, turning roller 204, turning roller 304, support roller 206, support roller 306, embossing belt 214, embossing belt 314, heating device 224, or any combination thereof; or, any combination thereof.

Signals generated by the detector sensors provide accurate feedback on the rotational position and speed of pressure roller 202, pressure roller 302, turning roller 204, turning roller 304, support roller 206, support roller 306, embossing belt 214, embossing belt 314, or a combination thereof.

Additionally, or alternatively, embosser 300 includes a direct mechanical drive or gear system linking the two or more embossing stations (e.g., the first embossing station and the second embossing station) together. Accordingly, deviations or discrepancies in the embossing patterns may be corrected by adjustment of the direct mechanical drive or engaging a clutch within the gear system.

As mentioned above, some embodiments of embosser 300 may be associated with one or more heating devices (e.g., heating device 224). Generally, the heating device is incorporated into systems where increasing the temperature of the to-be-embossed material is desirable prior to embossing. For example, it may be desirable to heat intentionally cooled polymer-based extruded materials prior to embossing. However, embosser 300 may also facilitate embossing of polymer-based extruded materials or other substrates where it is not desirable for the temperature of the substrate to be increased prior to embossing. For example, the polymer-based extruded material may already be at a desired temperature, or a cementitious material may already have the desired malleability shortly after the material exits a molding device. Accordingly, and with reference to FIG. 3B, some embodiments of embosser 300 may receive the substrate from a device 228. Device 228 may be an extrusion die, a press (e.g., a laminate press), injection mold, vacuum mold, or any other device that outputs a substrate in condition for embossing.

Additionally, some embodiments of embosser 300 may include one or more resistive elements 230. Generally, a resistive element facilitates, at least partial, maintenance of a substrates profile (e.g., width, thickness) before embossing, during embossing, after embossing, or a combination thereof. Said differently, the resistance element provides a rigid or semi-rigid barrier that, at least partially, prevents the pressure applied by the embosser 300 from unintentionally deforming the substrate's profile. Additionally, resistive elements 230 may facilitate the alignment of the polymer-based extruded material or other substrate. For example, as depicted in FIG. 2B, the resistive elements 230 may include a wall. The resistive elements 230 may extends from a point prior to where to the substrate is transported between support roller 206 and embossing belt 214 such that the pressure roller 202 applies sufficient resistive force to press the negative relief of embossing pattern 220 into a first surface of the substrate. The resistive elements 230 may be coextensive with the support roller 206, embossing belt 214, and pressure roller 202. The resistive elements 230 may extend between the support roller 206, embossing belt 214, and pressure roller 202 and pressure roller 302, support roller 306, and embossing belt 314. Similarly, the resistive elements 230 may extend past the support roller 306, embossing belt 314, and pressure roller 302. Though not depicted, the resistive elements 230 may also include a plurality of rollers. For example, a plurality of rollers may be aligned along the path the substrate takes through embosser 300.

Advantageously, embodiments of embosser 300 can facilitate embossing patterns of a multiplicative length without a repetition of the pattern. Said differently, where the length of embossing belt 214 and embossing belt 314 are not equal, and do not share a common divisor other than one (1), the total length of an embossing pattern created by embosser 300 is the least common multiple of the lengths of the two belts. For example, in an embodiment where a first embossing belt is 20 feet long (or where the loop formed from the first embossing belt has a circumference of 20 feet) and a second embossing belt is 19 feet long—the embossing pattern length is 380 feet, which is the least common multiple of 19 and 20. Accordingly, embosser 300 may facilitate embossing patterns that are multiplicatively longer than the lengths of the embossing belts. The total length of the embossed pattern may continue to multiplicatively lengthen as additional embossing rollers are incorporated in embosser 300.

Additionally, and advantageously, embosser 300 can facilitate embossing aesthetically complimentary patterns. For example, one of the embossing belts (e.g., embossing belt 214) may incorporate a wood grain pattern. A second embossing belt (e.g., embossing belt 314) may incorporate a “cut” or “sawn” pattern (e.g., cross cut or quarter sawn). Further, the embossing belt(s) may include other features that replicate naturally occurring elements associated with the desired esthetic (e.g., wood, stone, and so forth). For example, the first embossing belt may include a wood grain pattern while the second embossing belt may include swirl pattern(s), knot pattern(s), burl pattern(s), or any combination thereof. For another example, the first embossing belt may include ribbons or ripples while the second embossing belt may include veining, marbling, efflorescence, milk-spotting, or any combination thereof.

Additionally, though not depicted, it is contemplated that one or more support rollers (e.g., support roller 206) can be replaced with a pressure roller, turning roller, and embossing belt. Said differently, some embodiments of embosser 300 may be configured to emboss two surfaces of the substrate. For example, embosser 300 may emboss a pattern in second surface 312 of the polymer-based extrudate that is opposite the first surface 310 of the polymer-based extrudate 308.

With reference to FIGS. 4 and 5, an example substrate (e.g., embossed polymer-based extrudate) is provided in accordance with aspects described herein. The embossed polymer-based extrudate 400 comprises one or more polymeric resin mixtures. Embossed polymer-based extrudate 400 may be a single or multi-layer material. For example, the embossed polymer-based extrudate 400 depicted in FIGS. 4 and 5 comprise a polymer-based cap 414 and a polymer-based core 412. In such an embodiment, polymer-based cap 414 may comprise a first polymeric resin and polymer-based core 412 may comprise a second polymeric resin. The first polymeric resin may comprise olefins, polyolefins, rubbers, urethanes, polyurethanes, acrylics, polyacrylates, carbonates, polycarbonates, thermoplastic polyester elastomer, styrene-isobutylene block copolymers, or combinations thereof. For example, in some aspects the first polymeric resins HDPE, LDPE, PVC, or a combination therefore. Additionally, or alternatively, in some aspects the first polymeric resin includes a copolymer of ethylene and butly acrylate, such as Elvaloy™ by Dow®. The first polymeric resin can further include a base colorant, one or more additives, a variegating agent, or any combination thereof. In some aspects, embossed polymer-based extrudate 400 may include variegations 410. The second polymeric resin may comprise olefins, polyolefins, rubbers, urethanes, polyurethanes, acrylics, polyacrylates, carbonates, polycarbonates, thermoplastic polyester elastomer, styrene-isobutylene block copolymers, or combinations thereof. For example, in some aspects the second polymeric resins HDPE, LDPE, PVC, or a combination therefore. Additionally, or alternatively, in some aspects the second polymeric resin includes a copolymer of ethylene and butly acrylate, such as Elvaloy™ by Dow®. Additionally, the second polymeric resin may comprise a base colorant (e.g., base colorant 416), one or more secondary colorant (e.g., secondary colorant 418), one or more additives, filler, or any combination thereof.

The polymer-based cap 414 comprises a first polymeric resin. In an example aspect, the first polymeric resin comprises HDPE, LDPE, PVC, or a combination thereof. In some aspects the first polymeric resin includes a copolymer of ethylene and butly acrylate, such as Elvaloy™ by Dow®. The first polymeric resin can further include a base colorant, one or more additives, or any combination thereof.

Further, the polymer-based core 412 comprises a first planar surface 424, and a second planar surface 426 opposite the first planar surface 424. In some aspects, the polymer-based cap 414 comprises a first cap portion 420 and second cap portion 422. The first cap portion 420 of the cap 414 is adjacent the first planar surface 424 of the polymer-based core 412. The second cap portion 422 of the polymer-based cap 414 is adjacent the second planar surface 426 of the polymer-based core 412. In some aspects, the first cap portion 420 and the second cap portion 422 of the polymer-based cap 414 can encapsulate the polymer-based core 412. However, it is also contemplated that the first cap portion 420 and the second cap portion 422 of the polymer-based cap 414 are co-extensive with the first planar surface 424 and the second planar surface 426 of the polymer-based core 412. Further, in some aspects, the first cap portion 420 and the second cap portion 422 can partially encapsulate the polymer-based core 412.

Further, the embossed polymer-based extrudate 400 has a gauge (thickness) 406, a width 402, and a length 404. The length 404 of the embossed polymer-based extrudate 400 may be any thickness and may vary based on the intended use. For example, in some aspects, the gauge 406 is 0.25 inches (6.35 mm), 0.50 inches (12.7 mm), 1.00 inches (25.4 mm), 1.25 inches (31.75 mm), or 1.50 inches (38.1 mm). In some aspects, the gauge 406 is within a range of 0.25 inches (6.35 mm) and 1.50 inches (38.1 mm).

The width 402 of the embossed polymer-based extrudate 400 may be any width and may vary based on the intended use. For example, in some aspects, the width 402 is 3 inches (76.2 mm) or 152 inches (3860.8 mm). In some aspects, the width 402 is between 3 inches (76.2 mm) and 152 inches (3860.8 mm). The length 404 may be any length and may vary based on the intended use. In some aspects, the length 404 is between 0.5 feet (ft.) (0.1524 m) and 60 ft. (18.288 m).

Continuing, and with specific reference to FIG. 4, a top view of an example embossed polymer-based extrudate 400 is depicted in accordance with aspects described herein. The embossed polymer-based extrudate 400 may be illustrative of aspects of embossed polymer-based extrudate 108 of FIG. 1, 222 of FIG. 2A, or 322 of FIG. 3A. After extrusion, a polymer-based extrudate can be embossed with an embossing pattern by embosser, such as embosser 106 of FIG. 1. The embossing pattern 408 is the positive form negative relief of embossing pattern (e.g., negative relief of embossing pattern 220, negative relief of embossing pattern 320, or a combination of both). The embossing pattern may be patterned in any suitable configuration to include emulations of naturally occurring textures (such as quarter sawn woodgrains, rift sawn woodgrains, plain sawn woodgrains, rough-hewn stone, and so forth) or artificial textures designed for aesthetic appeal or increased friction/traction.

As mentioned above, aspects of the embossing systems described in relation to FIGS. 2A, 2B, 3A, and 3B may apply embossing pattern on a surface of any material, such as polymeric-based building materials; laminate, composite, or vinyl flooring; cement, clay, polymeric or composite floor, wall, or roofing tile; polymeric or composite furniture, countertops or cabinetry; polymer or composite decorative films/paper; or any material that is pliable enough to take a pattern prior to, and retain after, cooling, drying, curing, or hardening. Said differently, polymer-based extrudate 208 and polymer-based extrudate 308 are examples of substrates that may be embossed by the described embossing systems.

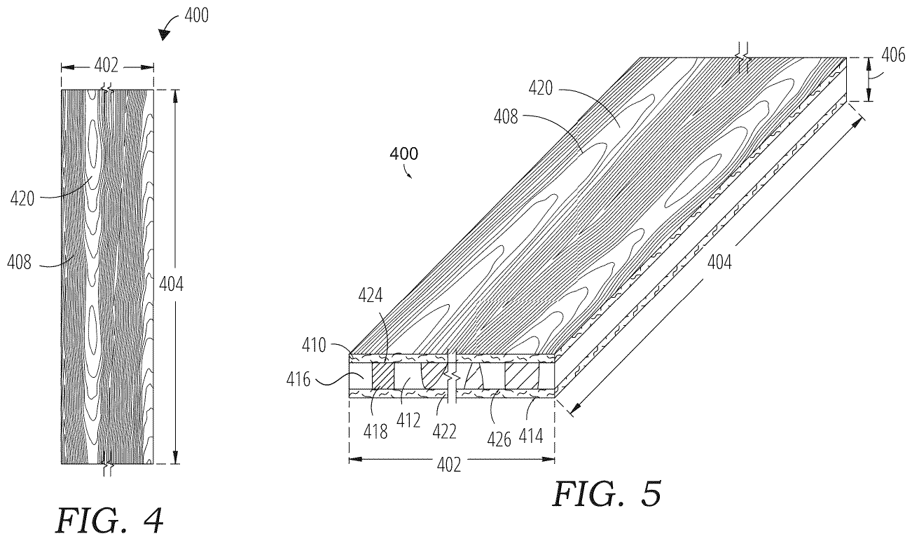

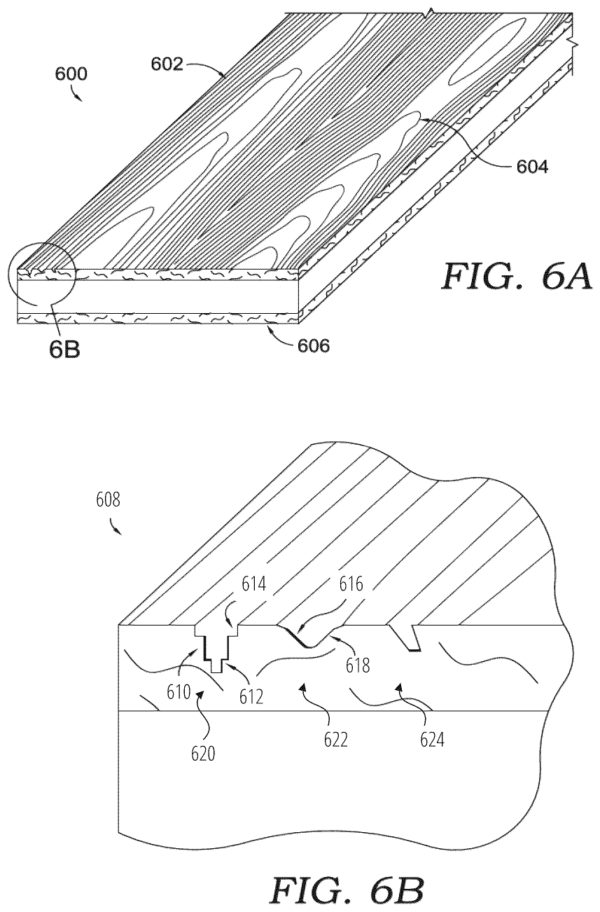

For example, and with reference to FIG. 6A and FIG. 6B, example embossed material 600 is depicted. Embossed material 600 may be a single or multi-layer material. For example, embossed material 600 may be laminate, composite, or vinyl flooring material; cement, clay, polymeric or composite floor, wall, or roofing material; polymeric or composite furniture components, countertops or cabinetry; polymer or composite decorative films/paper; or any other material that is pliable enough to take a pattern prior to, and retain after, cooling, drying, curing, or hardening. Embossed material 600 includes a first surface 602 and second surface 606. The first surface 602 includes embossing pattern 604. An embossing pattern may include three dimensional patterns, colorants, or a combination thereof. For example, three dimensional patterns may include patterns configured enhanced grip, anti-slip properties, aesthetic detailing, or a combination thereof. These three dimensional patterns may include undulations, grain, repeated shapes, or any other desired profile. The colorant patterns may include mono-chromatic, di-chromatic, or poly-chromatic variegations, highlights, shadows, or any combination thereof. In some embodiments, the colorant is comprised of one or more inorganic compounds. For example, the inorganic compounds can include metal oxides, mixed oxides, sulfides, chromates, and molybdates.

For example, an illustratively enlarged portion 608 of embossed material 600 is depicted in FIG. 6B. As depicted, some aspects of an embossing pattern may include one or more profiles depending on the desired properties and aesthetic. For example, the embossing pattern 604 is depicted with profile 620, profile 622, and profile 624. Each profile may include portions that include a first colorant (e.g., portion 610 and portion 616), a second colorant (e.g., portion 612), no additional colorant (e.g., portion 614 and portion 618), or any combination thereof. For example, a colorant may be deposited at predetermined points of a negative relief of embossing pattern (e.g., negative relief of embossing pattern 220, negative relief of embossing pattern 320, or both) via a colorant deposition system (e.g., digital print, flexographic, and so forth) that is incorporated into an embosser (e.g., embosser 200 or embosser 300). Said differently, a colorant may be deposited onto a peak, or a portion of a peak, of the negative relief of embossing pattern such that after embossing the colorant is deposited or embedded into the embossed surface of the substrate material.

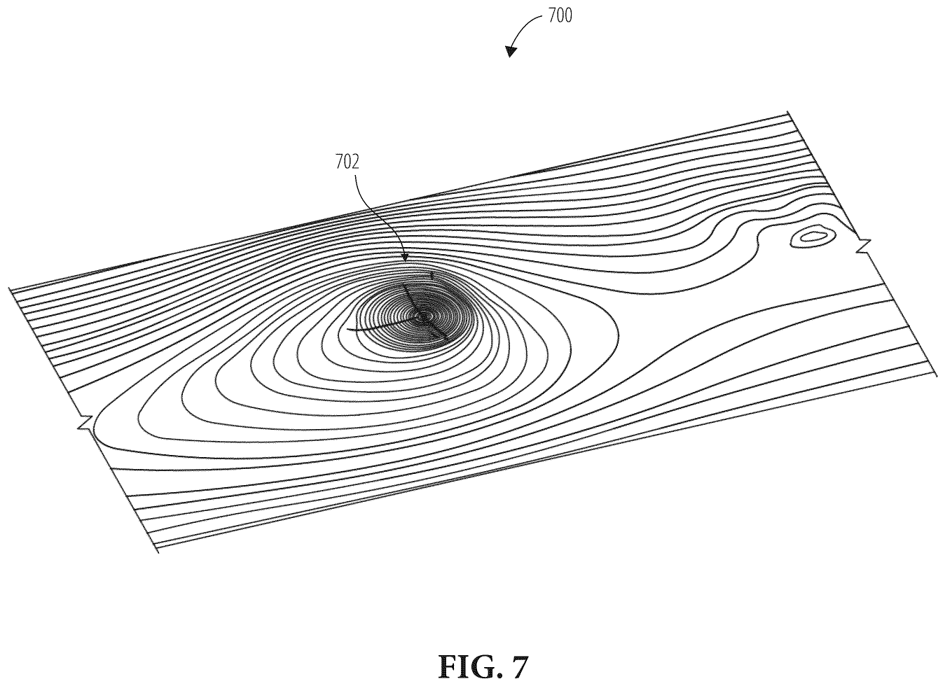

For another example, and with reference to FIG. 7, a portion of embossed material 700 is depicted. As previously mentioned, embodiments of the embosser described herein can embossing complimentary patterns. One embossing belt (e.g., embossing belt 214 of FIG. 3A) may incorporate a first pattern (e.g., the negative relief of a wood grain pattern). A second embossing belt (e.g., embossing belt 314 of FIG. 3A) may incorporate a second pattern such as the negative relief of one or more knots 702. Although not depicted in FIG. 7, the embossing patterns can include other patterns such as, but not limited to, ribbons, ripples, veining, marbling, efflorescence, milk-spotting, or any combination thereof.

From the foregoing, it will be seen that this invention is one well adapted to attain all the ends and objects hereinabove set forth together with other advantages which are obvious, and which are inherent to the structure.

It will be understood that certain features and subcombinations are of utility and may be employed without reference to other features and subcombinations. This is contemplated by and is within the scope of the claims.

While specific elements and steps are discussed in connection to one another, it is understood that any element and/or steps provided herein is contemplated as being combinable with any other elements and/or steps regardless of explicit provision of the same while still being within the scope provided herein. Since many possible embodiments may be made of the disclosure without departing from the scope thereof, it is to be understood that all matter herein set forth or shown in the accompanying drawings is to be interpreted as illustrative and not in a limiting sense.

As used herein and in connection with the statements listed hereinafter, the terminology “any of clauses” or similar variations of said terminology is intended to be interpreted such that features of clauses may be combined in any combination. For an illustrative example, a clause 4 may indicate the method/apparatus of any of clauses 1 through 3, which is intended to be interpreted such that features of clause 1 and clause 4 may be combined, elements of clause 2 and clause 4 may be combined, elements of clause 3 and 4 may be combined, elements of clauses 1, 2, and 4 may be combined, elements of clauses 2, 3, and 4 may be combined, elements of clauses 1, 2, 3, and 4 may be combined, and/or other variations. Further, the terminology “any of clauses” or similar variations of said terminology is intended to include “any one of clauses” or other variations of such terminology, as indicated by some of the examples provided above.

Clause 1. An embossing system, comprising a heating device positioned to expose a first surface of a substrate to thermal energy generated by a heat source; and a first embosser positioned to apply an embossing pattern to the first surface of the substrate after exposure to the thermal energy generated by the heat source, the first embosser having a turning roller rotationally engageable with a first portion of an inner surface of an embossing belt, a pressure roller rotationally engageable with a second portion of the inner surface of the embossing belt, the embossing belt forming a loop with the inner surface and an outer surface, wherein at least a portion of the outer surface includes a negative relief of the embossing pattern disposed thereon, and a support roller positioned to receive a second surface of the substrate that is opposite the first surface of the substrate while at least a portion of the negative relief is pressed at least partially into the first surface of the substrate.

Clause 2. The embossing system of clause 1, wherein the heat source includes nickel-chromium alloy, iron-chromium-aluminum alloy, molybdenum disilicide, silicon carbide, or gas fired radiant burners.

Clause 3. The embossing system of clause 1, wherein the thermal energy is generated by the heat source via combustion of gas, oil, or kerosene.

Clause 4. The embossing system of any of clauses 1-3, further comprising a control unit communicatively coupled to the turning roller and the pressure roller, the control unit including non-transitory computer readable storage media storing instructions that, when executed by the controlling unit, cause the controlling unit to perform operations including: synchronizing a first rate of rotation applied to drive rotation of the turning roller and a second rate of rotation applied to drive rotation of the pressure roller.

Clause 5. The embossing system of clause 4, wherein the embossing belt includes a locating indicator corresponding to a first position of the negative relief of the embossing pattern.

Clause 6. The embossing system of clause 5, wherein the locating indicator comprises a computer understandable code.

Clause 7. The embossing system of clause 6, wherein the computer understandable code includes an optical encoded pattern.

Clause 8. The embossing system of any of clauses 1-7, further comprising a second embosser positioned to apply another embossing pattern to the first surface of the substrate after exposure to the thermal energy generated by the heat source, the second embosser including another pressure roller rotationally engageable with another embossing belt, the other embossing belt including a negative relief of the embossing pattern disposed thereon.

Clause 9. The embossing system of clause 8, wherein the outer surface of the other embossing belt includes a colorant.

Clause 10. The embossing system of clauses 8 or 9, further comprising a control unit communicatively coupled to the first embosser and the second embosser, the control unit including non-transitory computer readable storage media storing instructions that, when executed by the controlling unit, cause the controlling unit to perform operations including synchronizing a first rate of rotation of the first embosser and a second rate of rotation of the second embosser.

Clause 11. The embossing system of any of clauses 1-10, wherein the substrate is a polymer-based extrudate.

Clause 12. An embossing device, comprising a first embosser positioned to apply an embossing pattern to the first surface of the substrate after exposure to the thermal energy generated by the heat source, the first embosser having a turning roller rotationally engageable with a first portion of an inner surface of the an embossing belt, a pressure roller rotationally engageable with a second portion of the inner surface of the embossing belt, the embossing belt forming a continuous loop and having a the inner surface and an outer surface, wherein at least a portion of the outer surface includes an negative relief of the embossing pattern disposed thereon, and a support roller positioned to receive a second surface of the substrate that is opposite the first surface of the substrate while at least a portion of the negative relief is pressed at least partially into the first surface of the substrate.

Clause 13. The embossing device of clause 12, wherein the thermal energy is generated by the heat source via combustion of gas, oil, or kerosene.

Clause 14. The embossing device of clause 12, wherein the heat source includes nickel-chromium alloy, iron-chromium-aluminum alloy, molybdenum disilicide, or silicon carbide.

Clause 15. The embossing device of any of clauses 12-14 further comprising, a heating element positioned to expose a first surface of a substrate to thermal energy generated by a heat source.

Clause 16. The embossing device of any of clauses 12-14 further comprising, a control unit communicatively coupled to the turning roller and the pressure roller, the control unit including non-transitory computer readable storage media storing instructions that, when executed by the controlling unit, cause the controlling unit to perform operations including synchronizing a first rate of rotation applied to drive rotation of the turning roller and a second rate of rotation applied to drive rotation of the pressure roller.

Clause 17. The embossing device of clause 16, wherein the embossing belt includes a locating indicator corresponding to a first position of the negative relief of the embossing pattern. Clause 18. The embossing device of clause 17, wherein the locating indicator comprises a computer understandable code.

Clause 19. The embossing device of clause 18, wherein the computer understandable code includes an optical encoded pattern.

Clause 20. The embossing device of any of clauses 12-19, further comprising a second embosser positioned to apply another embossing pattern to the first surface of the substrate after exposure to the thermal energy generated by the heat source, the second embosser including another pressure roller rotationally engageable with another embossing belt, the other embossing belt including a negative relief of the embossing pattern disposed thereon.

Clause 21. The embossing device of any of clauses 12-20, wherein the substrate is a polymer-based extrudate.

What is claimed is:

1. An embossing system, comprising:
a heating device positioned to expose a first surface of a substrate to thermal energy generated by a heat source; and
a first embosser positioned to apply an embossing pattern to the first surface of the substrate after exposure to the thermal energy generated by the heat source, the first embosser having
a turning roller rotationally engageable with a first portion of an inner surface of an embossing belt,
a pressure roller rotationally engageable with a second portion of the inner surface of the embossing belt, the embossing belt forming a loop with the inner surface and an outer surface, wherein at least a portion of the outer surface includes a negative relief of the embossing pattern disposed thereon, and
a support roller positioned to receive a second surface of the substrate that is opposite the first surface of the substrate while at least a portion of the negative relief is pressed at least partially into the first surface of the substrate.

2. The embossing system of claim 1, wherein the heat source includes nickel-chromium alloy, iron-chromium-aluminum alloy, molybdenum disilicide, silicon carbide, or gas fired radiant burners.

3. The embossing system of claim 1, wherein the thermal energy is generated by the heat source via combustion of gas, oil, or kerosene.

4. The embossing system of claim 1, further comprising a control unit communicatively coupled to the turning roller and the pressure roller, the control unit including non-transitory computer readable storage media storing instructions that, when executed by the controlling unit, cause the controlling unit to perform operations including:
synchronizing a first rate of rotation applied to drive rotation of the turning roller and a second rate of rotation applied to drive rotation of the pressure roller.

5. The embossing system of claim 4, wherein the embossing belt includes a locating indicator corresponding to a first position of the negative relief of the embossing pattern.

6. The embossing system of claim 5, wherein the locating indicator comprises a computer understandable code.

7. The embossing system of claim 6, wherein the computer understandable code includes an optical encoded pattern.

8. The embossing system of claim 1, further comprising:
a second embosser positioned to apply another embossing pattern to the first surface of the substrate after exposure to the thermal energy generated by the heat source, the second embosser including another pressure roller rotationally engageable with another embossing belt, the other embossing belt including a negative relief of the embossing pattern disposed thereon.

9. The embossing system of claim 8, wherein the outer surface of the other embossing belt includes a colorant.

10. The embossing system of claim 8, further comprising a control unit communicatively coupled to the first embosser and the second embosser, the control unit including non-transitory computer readable storage media storing instructions that, when executed by the controlling unit, cause the controlling unit to perform operations including:
synchronizing a first rate of rotation of the first embosser and a second rate of rotation of the second embosser.

11. The embossing system of claim 1, wherein the substrate is a polymer-based extrudate.

12. An embossing device, comprising:
a first embosser positioned to apply an embossing pattern to the first surface of the substrate after exposure to the thermal energy generated by the heat source, the first embosser having
a turning roller rotationally engageable with a first portion of an inner surface of an embossing belt,
a pressure roller rotationally engageable with a second portion of the inner surface of the embossing belt, the embossing belt forming a continuous loop and having a the inner surface and an outer surface, wherein at least a portion of the outer surface includes an negative relief of the embossing pattern disposed thereon, and
a support roller positioned to receive a second surface of the substrate that is opposite the first surface of the substrate while at least a portion of the negative relief is pressed at least partially into the first surface of the substrate.

13. The embossing device of claim 12, wherein the thermal energy is generated by the heat source via combustion of gas, oil, or kerosene.

14. The embossing device of claim 12 further comprising, a heating element positioned to expose a first surface of a substrate to thermal energy generated by a heat source.

15. The embossing device of claim 12, wherein the heat source includes nickel-chromium alloy, iron-chromium-aluminum alloy, molybdenum disilicide, or silicon carbide.

16. The embossing device of claim 12, further comprising a control unit communicatively coupled to the turning roller and the pressure roller, the control unit including non-transitory computer readable storage media storing instructions that, when executed by the controlling unit, cause the controlling unit to perform operations including:
synchronizing a first rate of rotation applied to drive rotation of the turning roller and a second rate of rotation applied to drive rotation of the pressure roller.

17. The embossing device of claim 16, wherein the embossing belt includes a locating indicator corresponding to a first position of the negative relief of the embossing pattern.

18. The embossing device of claim 17, wherein the locating indicator comprises a computer understandable code.

19. The embossing device of claim 18, wherein the computer understandable code includes an optical encoded pattern.

20. The embossing device of claim 12, further comprising:
a second embosser positioned to apply another embossing pattern to the first surface of the substrate after exposure to the thermal energy generated by the heat source, the second embosser including another pressure roller rotationally engageable with another embossing belt, the other embossing belt including a negative relief of the embossing pattern disposed thereon.
